(19) United States
(12) Patent Application Publication
(10) Pub. No.: US 2019/0243353 A1
(43) Pub. Date: Aug. 8, 2019

(54) REMOTE CONTROL UNIT FOR AN INDUSTRIAL TRUCK AND ASSOCIATED SYSTEM

(71) Applicant: Jungheinrich Aktiengesellschaft, Hamburg (DE)

(72) Inventors: Julia Daimer, Fuerth (DE); Till Muhl, Hamburg (DE)

(73) Assignee: Jungheinrich Aktiengesellschaft, Hamburg (DE)

(21) Appl. No.: 16/265,182

(22) Filed: Feb. 1, 2019

(30) Foreign Application Priority Data
Feb. 2, 2018 (DE) 10 2018 102 427.4

(51) Int. Cl. G05D 1/00; B66F 9/075

(52) U.S. Cl. CPC G05D 1/0016; G05D 2201/0216; G05D 1/0022; B66F 9/07581

(57) ABSTRACT

A remote control unit for an industrial truck comprises a transmitting and receiving unit configured to establish a radio connection with one of the industrial truck and a control unit. A handle element is configured to be gripped by an operator's hand and grasped with an inner side of the operator's gripping hand and associated fingers, wherein the associated fingers do not include a thumb. A function element is positioned at an angle relative to the handle element and comprises a first control element configured to be operated using the thumb of the operator's gripping hand. The function element further comprises a scanning unit configured to detect data and transmit data by the transmitting and receiving unit.

### CROSS REFERENCE TO RELATED INVENTION

This application is based upon and claims priority to, under relevant sections of 35 U.S.C. § 119, German Patent Application No. 10 2018 102 427.4, filed Feb. 2, 2018, the entire contents of which are hereby incorporated by reference.

### BACKGROUND

The present invention relates to a remote control unit for an industrial truck, as well as a system comprising such a remote control unit and an industrial truck.

Ergonomic control of industrial trucks is a primary goal in their further development. Industrial trucks are generally used in a work environment that poses strong demands on the safety of the operator as well as the efficiency of operation. A wide range of approaches are known for remote control. It is for example known to use a driverless, voice-controlled reach truck that is controlled using words and gestures, wherein its environment is optically detected with the assistance of 3-D cameras so that the driving path can be adapted thereto.

In the use of picking carts, it is known, for example from the company Crown, to provide a glove with a control element for a horn and an emergency off on its back, whereas forward travel is initiated by a button placed on the index finger.

Moreover, a HoloLens is known from the company Microsoft which comprises wearable glasses that show additional information in its field of vision. Control occurs through various hand signals by the operator.

A system for remotely controlling an industrial truck is known from DE 10 2008 025 632 B4 with a mobile input and transmitting device in the form of a programmable cell phone, smart phone or PDA, and a receiving device provided on the industrial truck. Wireless control signals that can be received by the industrial truck are transmitted by the transmitting and receiving unit. The mobile input and transmitting device possesses a display designed as a touchscreen on which control elements for controlling the industrial truck are graphically portrayed, and which can be operated by touch.

### BRIEF SUMMARY OF THE INVENTION

The object of the invention is to improve a remote control unit for an industrial truck as well as a system comprising the remote control unit and the industrial truck such that extremely efficient use is possible with ergonomic operation.

A remote control unit for an industrial truck is provided and intended to control at least some functions of the industrial truck from a spatial distance. In an embodiment, the remote control unit comprises a transmitting unit by means of which a radio connection is established with the industrial truck and/or a higher-level control unit. Control commands inter alia are transmitted to the industrial truck by means of the transmitting unit. The remote control unit furthermore comprises a handle element and a function element. The handle element can be gripped manually, wherein it can be gripped with an inside of the hand and associated fingers (digits II-V) with the exception of the thumb (digit I). The function element is arranged angled on the handle element and has at least one first control element that can be operated using the thumb of the gripping hand. In an embodiment, the function element additionally comprises a scanning or reading unit that can detect data and forward data by the transmitting unit. In an embodiment, the remote control unit is connecting the remote control of the industrial truck to data detection by means of the scanning or reading unit. This provides an operator with a very effective way of, on the one hand, controlling the vehicle at a distance and, on the other hand, recording the data that is to be detected over the course of its work that arises and that is to be forwarded.

In an embodiment, the remote control unit also comprises a second control element on the handle element that can be actuated by one of the fingers of the gripping hand. In this manner, the remote control unit comprises two control elements for the user in a compact and efficient-to-use form that can be actuated just by the fingers of the gripping hand without grasping or any other movement.

In an embodiment, an acceleration unit is provided in the function element and/or the handle element that detects guided movements and can associate a control signal with one of the detected movements and transmit it by the transmitting unit. The provided acceleration unit connects a third essential feature with the remote control unit: Not only can at least two control units be actuated without grasping and data from the work can be detected and transmitted, gestures and hand movements can also be recognized as guided movements and converted into control signals. This expands the functionality of the remote control unit in an intuitive manner without providing control concepts that are difficult to distinguish. Preferably a three-axial acceleration sensor is provided in the acceleration unit that can detect a guided movement. A guided movement differs from a random movement or dropping the remote control unit in that the arising acceleration values remain within predetermined limits. The relative relationship of the acceleration values to each other can for example be used to recognize the guided movement. For this purpose, it is provided that the axes of the acceleration sensor possess a defined alignment within the handle element. The three-axis acceleration sensor preferably provides not just the acceleration values along an axis for better recognizing the acceleration movement, but also the sign of the acceleration so that said acceleration sensor is occasionally also termed a 6-axis acceleration sensor.

For ergonomic operation, it has proven to be particularly advantageous if the scanning or reading unit is triggered by an actuation of the second control element with the fingers, and detects the data to be transmitted when there is no or little movement. For the scanning or reading unit, this ensures that the data to be read is detected and forwarded only when the remote control unit is at rest or nearly at rest. This prevents accidental or unintentional transmitting of data. In one preferred embodiment, the scanning or reading unit is arranged in the remote control unit such that it can be directed toward the data carrier to be detected by the handle element.

In one embodiment, the function element comprises a display that is configured to depict data received by the scanning or reading unit. Preferably, the transmitting unit is configured as a transmitting and receiving unit that can receive data on an order and/or on goods from the industrial truck or from a higher-level control unit. In this case, the display is then configured to depict the received data.

With the transmitting unit configured as a transmitting and receiving unit, the remote control can assume very comprehensive tasks of a data terminal for the industrial truck. This includes the depiction of orders on the warehouse administration system and/or the detected load and goods. Warnings such as about hazardous goods and the like can thus also be displayed in an ergonomic manner on the remote control unit.

In an embodiment, the handle element is configured as an elongated handle which has two mutually opposing flat sides that preferably lie parallel to each other and two narrow sides each, wherein the inside surface of the hand at least lies against one of the flat sides and one of the narrow sides, and the fingers (digits II-V) enclose at least the other narrow side. The handle element is grasped and held similar to a tool handle or a gun. Preferably, the first control element is arranged on the narrow side grasped by the fingers. This can be a rocker switch that triggers a lifting and lowering function in the industrial truck. Other switches can be arranged on the flat side that is not covered by the inside surface of the hand.

Preferably, the second control element that is provided for actuation by the thumb is chosen as a rocker switch that enables a selection of the driving direction. Such a rocker switch can be intuitively operated by the thumb and enables precise control of the industrial truck by quickly switching from forward and reverse travel.

In an embodiment, a swinging or rotary movement occurs along a longitudinal axis of the handle as a guided movement. This guided movement can be detected by the movement unit and converted into a control command for a steering movement of the industrial truck. Such a movement is intuitively understandable and therefore facilitates the operation of the industrial truck. A rotary movement can for example be about a vertical axis that coincides with the longitudinal axis of the handle element. The swinging movement can in this case for example be by a hand movement with an extended arm, or from the wrist joint in which the pivot axis does not coincide with a longitudinal axis of the handle element but is approximately aligned parallel thereto.

The object according to the invention is also achieved by a system comprising an industrial truck and a remote control unit according to the invention. Preferably, the remote control unit can contain the functions provided in a drawbar head or in a steering transducer such that the industrial truck can be designed as an industrial truck without a drawbar. This yields a highly effective and easily steerable industrial truck, particularly for spatially tight working environments.

### BRIEF DESCRIPTION OF THE DRAWINGS

A preferred exemplary embodiment of the invention is explained in greater detail below with reference to the figures. In the following:

FIG. 1 illustrates a perspective view of an embodiment of a high lift truck without a drawbar; and

FIG. 2 illustrates a perspective view of an embodiment of a remote control unit with a hand.

### DETAILED DESCRIPTION OF THE INVENTION

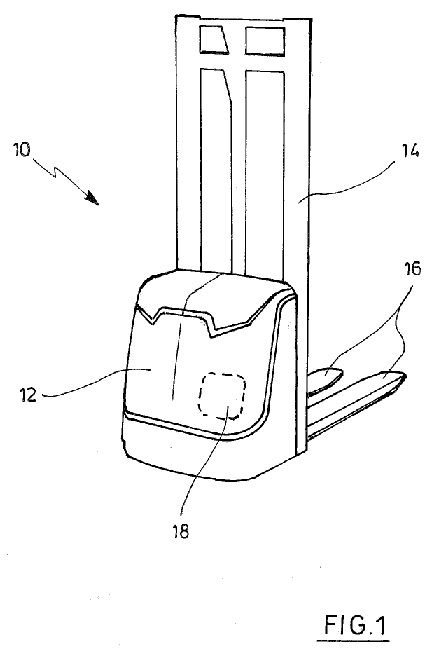

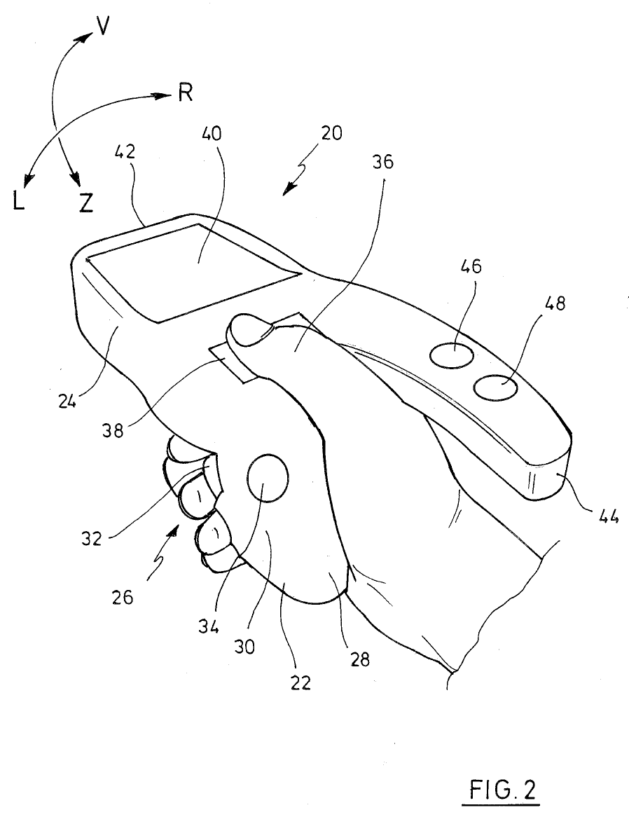

FIG. 1 shows a high lift truck 10 with a drive part 12 and a load part 14. The load part 14 possesses a high lifting frame with which a load carrying means 16 can be lifted. The industrial truck 10 possesses a transmitting and receiving unit 18 that is configured to exchange data and commands with a remote control unit 20 (FIG. 2), for example by Bluetooth or another radio standard.

The remote control unit 20 shown in FIG. 2 comprises a handle element 22 and a function element 24. The handle element 22 and function element 24 are arranged at an angle relative to each other so that they imitate the shape of a gun. The handle element 22 is grasped by the hand's inner surface (not visible) and the fingers 26. Digits II to V are designated as fingers which are occasionally also designated as long fingers. The handle element 22 comprises two flat and two narrow sides. The rear, narrow side 28 and the flat side 30 extending from the hand's inner surface are discernible in FIG. 2. The flat side 30 is exposed with the depicted handle element 22. A second control element 32 is attached to the front narrow side that can be actuated by the index or middle finger. An additional control element 34 is provided on the flat side 30. This can be actuated by the thumb 36, wherein actuation of the additional control element 34 by the thumb 36 then forms a nearly closed grasp. Alternatively, direct-selection buttons can be provided, for example for the thumb 36 in its depicted position. These direct selection buttons can for example be configured as a horn, follow-me, and as an actuation for a scanner.

The function element 24 comprises a control element 38 that can be actuated by the thumb 36. As shown in FIG. 2, the control element 38 is configured as a rocker on which the thumb 36 rests, for example to select a direction of travel. The function element 24 also comprises a display 40 on which an operator can read incoming data and information. Furthermore, a scanning unit 42 is provided on the side of the function element 24 extending from the hand. The scanning unit 42 can for example be configured as a barcode scanner by means of which data on the warehouse positions and goods can be read. The scanning unit 42 can also be configured as a reading unit that for example can read RFID transponders or other IDs. A projecting bar 44 is provided on the side of the function element 24 facing the operator. The bar 44 extends approximately up to the wrist of the operator and comprises two additional control elements 46, 48 that are provided for actuation with the free hand of the operator, i.e., not holding the remote control. The depicted embodiment is a version for right-handers; a corresponding version for left-handers is the reverse image of it, wherein the shown version can in principle also be used by left-handers.

When using the remote control unit 20, the actuating element 32 is triggered by an actuation of the index or middle finger of the right-hand With the actuating element 32, a lifting and a lowering function can be triggered in the industrial truck by a rocker switch. A function of the scanning unit 42 can be triggered by an actuation of the control element 34 with the thumb 36. If the actuating element 34 is held, it is accordingly checked whether the operator is holding the remote control unit calmly enough; only then is the scanning function actuated, and the data to be scanned are read. The travel direction can be selected by an actuation of the control element 38 with the thumb 36. Information on the moving order and the scanned data can be displayed on the display 40. For using the remote control unit, it has proven to be particularly advantageous when the control element 48 is configured as a button that triggers a lifting function in the vehicle. The button 46 is a follow-me function in which the vehicle follows the remote control unit at a predetermined and settable distance.

Guided movements can be distinguished from each other by the integrated acceleration sensor. For example, a control for the industrial truck to the left or to the right can be provided in which the remote control unit swings in direction R to the right, or in direction L to the left. The swinging movement can in this case be movement from the operator's wrist joint, or a movement originating from the operator's lower arm or even the entire arm. A steering command is produced for the vehicle with the assistance of the swinging movement, and it is also transmitted thereto. The acceleration values can be limited in this case such that an unintentional movement or movement that results from a body rotation can be distinguished from the desired movement.

A traveling vehicle in forward travel direction F and back opposite the travel direction can also be controlled by a hand movement. For this, the remote control unit is lifted or lowered, wherein lifting and lowering are preferably executed from the operator's lower arm; however it can also be triggered by a movement of the operator's wrist joint.

### REFERENCE NUMBER LIST

10 High lift truck
12 Drive part
14 Load part
16 Load bearing means
18 Transmitting and receiving unit
20 Remote control unit
22 Handle element
24 Function unit
26 Fingers
28 Narrow side
30 Flat side
32 First control element
34 Operating element
36 Thumb
38 Second control element
40 Display
42 Scanning or reading unit
44 Bar
46 Operating element
48 Operating element

1-20. (canceled)

21. A remote control unit for an industrial truck comprising:
a transmitting and receiving unit configured to establish a radio connection with one of the industrial truck and a control unit;
a handle element configured to be gripped by an operator's hand and grasped with an inner side of the operator's gripping hand and associated fingers, wherein the associated fingers do not include a thumb; and
a function element positioned at an angle relative to the handle element and comprising a first control element configured to be operated using the thumb of the operator's gripping hand, wherein the function element further comprises a scanning unit configured to detect data and transmit data by the transmitting and receiving unit.

22. The remote control unit according to claim 21, wherein the handle element comprises a second control element that is configured to be actuated by the associated fingers of the operator's gripping hand.

23. The remote control unit according to claim 21, further comprising an acceleration unit configured to detect a guided movement, and wherein the acceleration unit is further configured to associate a control signal with a detected movement and transmit the control signal by the transmitting and receiving unit.

24. The remote control unit according to claim 23, wherein the acceleration unit is positioned in one of the function element and the handle element.

25. The remote control unit according to claim 23, wherein the acceleration unit further comprises a 3-axis acceleration sensor.

26. The remote control unit according to claim 22, wherein the scanning unit is triggered by an actuation of the second control element, wherein a check is performed to confirm that the operator is holding the remote control unit in a calm manner wherein data is then scanned.

27. The remote control unit according to claim 21, wherein the function element comprises a display configured to depict data received by the scanning unit.

28. The remote control unit according to claim 27, wherein the transmitting and receiving unit is configured to receive data on an order and on goods from at least one of the industrial truck and the control unit, and wherein the display is configured to depict the received data.

29. The remote control unit according to claim 21, wherein the handle element further comprises an elongated grip comprising two mutually opposing flat sides and two narrow sides, and wherein an inner surface of the operator's gripping hand contacts at least one of the flat sides and one of the narrow sides, and the associated fingers enclose at least one of the narrow sides.

30. The remote control unit according claim 29, wherein the first control element is positioned on the narrow side enclosed by the associated fingers.

31. The remote control unit according to claim 21, wherein the first control element is configured as a rocker switch that triggers a lifting and lowering function in the industrial truck.

32. The remote control unit according to claim 22, wherein the second control element is configured as a rocker switch for selecting a direction of travel.

33. The remote control unit according to claim 21, further comprising a movement unit configured to detect at least one of a guided swinging and a rotary movement about a longitudinal axis of the handle element and convert the at least one of a guided swinging and a rotary movement about a longitudinal axis of the handle element detected into a control command for a steering movement of the industrial truck.

34. The remote control unit of claim 21, wherein the control unit is a higher-level control unit.

35. The remote control unit of claim 21, wherein the transmitting and receiving unit is configured to establish the radio connection with a transmitting and receiving unit of the industrial truck.

36. A control system for an industrial truck comprising:
a remote control unit comprising,
a transmitting and receiving unit configured to establish a radio connection with one of the industrial truck and a control unit,
a handle element configured to be gripped by an operator's hand and grasped with an inner side of the operator's gripping hand and associated fingers, wherein the associated fingers do not include a thumb; and
a function element positioned at an angle relative to the handle element and comprising,
a first control element configured to be operated using the thumb of the operator's gripping hand, and
a scanning unit configured to detect data and transmit data by the transmitting and receiving unit.

37. The control system according to claim 36, wherein the industrial truck does not comprise a drawbar.

38. The control system according to claim 36, further comprising at least one direct selection button positioned adjacent to the control element and configured to be operated by the thumb of the operator's gripping hand.

39. The control system of claim 36, wherein the control unit is a higher-level control unit.

40. The control system of claim 36, wherein the transmitting and receiving unit is configured to establish the radio connection with a transmitting and receiving unit of the industrial truck.
